(19) United States
(12) Patent Application Publication
(10) Pub. No.: US 2014/0063105 A1
(43) Pub. Date: Mar. 6, 2014

(54) INKJET PRINTING METHOD USING MODE SWITCHING

(71) Applicants: Douglas Wayne Couwenhoven, Fairport, NY (US); Christopher Rueby, North Chili, NY (US)

(72) Inventors: Douglas Wayne Couwenhoven, Fairport, NY (US); Christopher Rueby, North Chili, NY (US)

(21) Appl. No.: 13/602,358

(22) Filed: Sep. 4, 2012

(51) Int. Cl. B41J 29/38

(52) U.S. Cl. 347/15

(57) ABSTRACT

A method for printing an input digital image using and inkjet printer being adapted to print horizontal strips of print image data using one or more print passes. The method includes determining print image data and control channel image data for a particular strip responsive to input code values for corresponding input pixels, the control channel image data providing an indication of the number of print passes that should be used to print the input code values. A number of print passes for the particular strip is determined responsive to the control channel image data, and the inkjet printer is controlled to print the particular strip of print image data using the determined number of print passes.

### FIELD OF THE INVENTION

This invention pertains to the field of inkjet printing systems, and more particularly to a method for improving productivity by reducing the time required to print an image, while reducing image artifacts associated with the order in which inks are deposited on a receiver medium.

### BACKGROUND OF THE INVENTION

A typical inkjet printer reproduces an image by ejecting small drops of ink from a printhead containing ink nozzles, where the ink drops land on a receiver medium (typically paper) to form ink dots. A typical inkjet printer reproduces a color image by using a set of color inks, usually cyan, magenta, yellow, and black, although many other combinations of ink colors are known to be used in the art.

One attribute of modern inkjet printers is that they typically possess the ability to vary (over some range) the amount of each ink that is deposited at a given location on the page. Inkjet printers with this capability are referred to as “multitone” inkjet printers because they can produce multiple density tones at each location on the page. Some multitone inkjet printers achieve this by varying the volume of the ink drop produced by the nozzle by changing the electrical signals sent to the nozzle or by varying the diameter of the nozzle. See for example U.S. Pat. No. 4,746,935 to Allen, entitled “Multitone ink jet printer and method of operation.” Other multitone inkjet printers produce a variable number of smaller, fixed size droplets that are ejected by the nozzle, all of which are intended to merge together and land at the same location on the page. See for example U.S. Pat. No. 5,416,612 to Ingraham et al., entitled “Apparatus and method for producing color half-tone images.” These techniques allow the printer to vary the size or optical density of a given ink dot, which produces a range of density levels at each location, thereby improving the image quality.

Another common way for a multitone inkjet printer to achieve multiple density levels is to print a small amount of ink at a given location on several different passes of the printhead over that location. This results in the ability to produce a greater number of density levels than the nozzle can fundamentally eject, due to the buildup of ink at the given location over several passes. See, for example, U.S. Pat. No. 5,923,349 to Meyer, entitled “Density-based print masking for photographic-quality ink-jet printing.”

Many inkjet printers employ a printhead having an array of ink nozzles that is passed horizontally over the receiver medium to print the ink drops that form the image in horizontal strips. Each motion of the printhead horizontally across the receiver medium is called a “print pass,” a “print swath,” or simply a “swath.” The receiver medium is then advanced vertically after each pass of the printhead, and the next strip of the image is printed, and so on. The amount of the vertical advance may or may not be equal to the height of the printhead. If the vertical advance is less than the height of the printhead, then the printhead will pass over a given location on the page multiple times, resulting in multiple opportunities to eject ink drops that all land at the same location. Such techniques are commonly referred to as “print masking” or “multi-pass printing”, and are well known in the art. See, for example, commonly-assigned U.S. Pat. No. 7,715,043 to Billow et al., entitled “Multilevel print masking method.” It is also common for the printhead to print in both a left-to-right direction across the page, and a right-to-left direction across the page. This technique is commonly known as “bi-directional” printing, and results in improved print times due to the fact that the printhead does not need to return to the original starting position before the next swath is printed, as it simply prints in the opposite direction as the previous swath. This technique is well known to those skilled in the art.

For inkjet printers that eject a single fixed size ink drop at each location in each pass of the printhead, the number of ink drops destined to be printed at a given location within a strip determines a lower bound on the number of passes of the printhead that are required to complete the printing. The more passes of the printhead that are required to print each strip, the longer the time will be to completely print the page. Thus, to improve customer satisfaction, there is a need to print an image in as little time as possible, using the fewest passes of the printhead over the receiver medium as possible.

U.S. Pat. No. 5,600,353 to Hickman, et al., entitled “Method of transitioning between ink jet printing modes,” describes a method of transitioning back and forth between black print swaths and color print swaths within an image to improve print time.

U.S. Pat. No. 6,257,698 to Bloomberg, et al., entitled “Method of ink jet printing with varying density masking printing and white space skipping for faster paper advancement,” describes a method of switching between a color print mode and a black print mode in an inkjet printer having a color nozzle array and a black nozzle array.

U.S. Pat. No. 6,533,393 to Meyer, et al., entitled “Printer with multiple printmodes per swath,” describes a method of identifying colored regions and monochrome regions within a print, and printing the monochrome regions using fewer passes than the colored regions to improve the print time.

Commonly-assigned U.S. Patent Application Publication 2012/0001975 to Rueby entitled “Efficient data scanning for print mode switching,” describes a method of inspecting raster lines of image data downstream from the current print swath to determine if any colored ink is required or if only black ink is required, and then switching into a grayscale or color print mode accordingly.

Another aspect of inkjet printers is that often different colors can result from depositing the inks in a different order on the page. For example, if a cyan ink drop is printed on top of a magenta ink drop, you get a different color than if a magenta drop is printed on top of a cyan ink drop. This situation often occurs as a result of bi-directional printing. Even though the amount of each colored ink is the same in each case, the different order of deposition causes a different color to be perceived. This effect can be particularly large and visually objectionable when vertically adjacent strips of the image are printed in a single pass but with opposite print directions. This effect is commonly known as “chromatic banding,” and is known in the prior art as a significant problem with inkjet printing systems. Many techniques have been disclosed as attempts to reduce or compensate for chromatic banding. For example, see commonly-assigned U.S. Patent Application Publication 2010/0013878 to Spaulding et al., entitled “Bi-directional print masking;” U.S. Patent Application Publication 2003/0048327 to Serra et al., entitled “Color correction for bi-directional printing in inkjet printers;” U.S. Patent Application Publication 2012/0013665 to Vall et al., entitled “Fluid ejection printing with automatic print mode switching;” U.S. Pat. No. 6,354,692 to Ross, entitled “Method and apparatus for minimizing color hue shifts in bi-directional inkjet printing;” and U.S. Pat. No. 7,054,034 to Underwood, entitled “Printing apparatus and method for generating direction dependent color map.”

There remains a need for reducing print time in a color inkjet printer, without producing objectionable image artifacts, such as chromatic banding.

### SUMMARY OF THE INVENTION

In accordance with the present invention, there is provided a method of using an inkjet printer to print an input digital image having a plurality of rows and columns of input pixels, each input pixel having an input color specified by input code values for one or more input color channels, wherein the inkjet printer includes a printhead having ink nozzles for printing print image data by ejecting ink drops of one or more ink colors for an array of printer pixels, said inkjet printer being adapted to print horizontal strips of print image data using one or more print passes, comprising:

a) determining print image data for a particular strip responsive to input code values for corresponding input pixels, the print image data providing an indication of a number of ink drops of each ink color to be printed for corresponding printer pixels;

b) determining control channel image data for the particular strip responsive to the input code values for the corresponding input pixels;

c) determining a number of print passes for the particular strip responsive to the determined control channel image data;

d) controlling the inkjet printer to print the particular strip of print image data using the determined number of print passes; and

e) repeating steps a)-d) for each strip required to print the input digital image.

It is an advantage of the present invention that print time is reduced by printing each strip of the image in as few passes as are possible, based on the number of ink drops required for each ink color in each strip.

It is another advantage of the present invention that the number of print passes used to print a strip of the image is determined based on the number of drops of each ink that are required to print each location in the strip, regardless of whether the strip contains colored ink only, black ink only, or a combination of both colored and black inks.

It is yet another advantage that images are reproduced that are substantially free of chromatic banding artifacts, resulting in high print quality and low print time.

### BRIEF DESCRIPTION OF THE DRAWINGS

FIG. 1 is a flow diagram of an inkjet image processing pipeline;

FIG. 2 is a picture showing an example of an input digital image;

FIG. 3 is a picture showing color managed image data corresponding to the input digital image of FIG. 2;

FIG. 4 is a picture showing print image data corresponding to the input digital image of FIG. 3;

FIG. 5 is a picture showing image strips;

FIG. 6 is a flow diagram of an inkjet image processing pipeline in accordance with the present invention;

FIG. 7 is a picture showing control channel image data;

FIG. 8 is a picture showing halftone control channel image data;

FIG. 9 is a picture showing image strips;

FIG. 10 is a picture showing control channel image data;

FIG. 11 is a picture showing halftone control channel image data;

FIG. 12 is a is a picture showing image strips, and;

FIG. 13 is a flow diagram of a method for forming a color look-up table in accordance with the present invention.

### DETAILED DESCRIPTION OF THE INVENTION

Many of the above mentioned prior art techniques improve print time by switching to a faster print mode for black regions, and use a slower print mode to print color regions. This is often accomplished by using a fewer number of print passes for the black regions, and a higher number of print passes for the colored regions. Often, the black regions can be printed using a single drop of black ink, printed in a single pass of the printhead over the page, while the colored ink regions may require more than one drop of a particular color ink, and therefore requires more than one pass of the printhead over a particular location to deposit the required number of colored ink drops in order to achieve the desired color. For example, a particular blue color may require two drops of cyan ink and two drops of magenta ink at each printing location on the page. This blue color would therefore require at least two passes of the printhead over the page to deposit the number of colored ink drops required to reproduce the blue color. However, a lighter shade of blue color might require only one drop of cyan ink and one drop of magenta ink. If a strip of image data contained only this light blue color, it could be printed in a single pass of the printhead over the page, resulting in improved throughput and decreased print time.

There are often many lighter colors (which can be referred to as “lighter colors” or “one pass colors”) that require at most one drop of any of the ink colors, and therefore can be printed in one pass of the printhead. The present invention takes advantage of this aspect such that any strip that contains only lighter colors will print in one pass, regardless of whether the strip contains black, color, or a mixture of black and color information. This is a significant departure from the prior art techniques, which use the presence of color information in a strip to select a slower print mode for that strip.

While the ability to print colored information in a single pass of the printhead provides for a significant print speed advantage (due to fewer passes of the printhead required to print the page), it has been observed for some lighter colors that even though they are capable of being printed in one pass (because they only require at most one drop of any ink color), chromatic banding artifacts can occur due to the inverted ink lay-down order from bi-directional one pass printing. It should be noted that only some of the lighter colors will exhibit objectionable chromatic banding when printed in a one-pass, bi-directional print mode; and not all lighter colors will exhibit objectionable chromatic banding. For example, a cyan color that requires only one drop of cyan ink will not show any chromatic banding, because it does not matter if the strip of the image containing the cyan color is printed left-to-right or right-to-left, since the ink deposition order is the same in either case. However, a green color having one drop of cyan ink and one drop of yellow ink may show objectionable chromatic banding when subsequent strips of the image are printed in alternating print directions. The present invention compensates for this by providing a method for indicating which of the lighter colors will show objectionable levels of chromatic banding, and flagging those colors as requiring more than one pass to print, thereby forcing the printer to print those colors using at least two passes to preserve high image quality. The present invention will now be described in detail herein below.

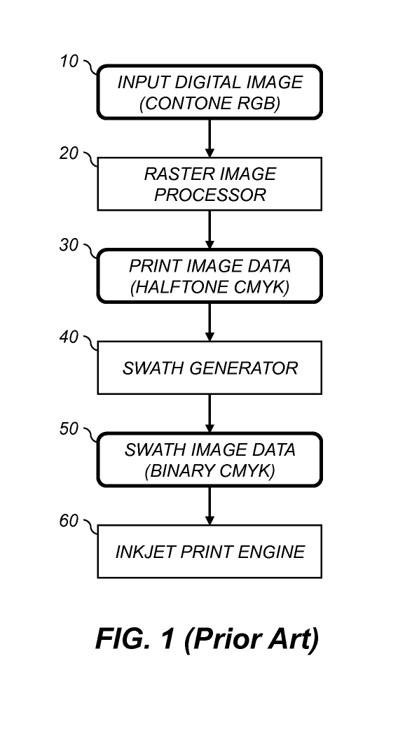

Turning to FIG. 1, a generic image processing pipeline for an inkjet printer system is shown. An input digital image 10 is typically specified as a two dimensional array of individual input pixels that specify the color of the input image at each location. Each input pixel typically contains a continuous tone (i.e., “contone”) value on the range 0-255 for a plurality of input color channels, typically red, green, and blue (i.e., “RGB”). These values are commonly called “input code values.” One skilled in the art will understand that the range of the input code values and the number and particular colors of the input color channels may vary, and are not a fundamental aspect of the present invention.

The input digital image 10 is typically provided by an application program running on a computer, but may come from a variety of sources. The input digital image 10 is then processed by a raster image processor 20 to create print image data 30. The raster image processor 20 may be implemented in hardware or software running inside a host computer or inside an inkjet printer, and contains a number of image processing algorithms that are required to convert the input digital image 10 into a form that can be sent to an inkjet printer. These algorithms include resizing, sharpening, color correction, halftoning, and others, and will be familiar to those skilled in the art. The details of the raster image processor 20 that are specific to the present invention will be discussed later.

The print image data 30 has been converted from an input color space, typically RGB, to the color space of the printer's inks, typically cyan, magenta, yellow, and black (CMYK). The invention will apply equally well to any set of colorants, as one skilled in the art will understand. The print image data 30 has also been processed by the raster image processor 20 to reduce the number of density levels from the original 256 levels in the input digital image, down to match the number of printing levels available in the inkjet printer, which is typically on the range of 2-8. The algorithm that performs this bit depth reduction is called generally “halftoning” or “multitoning,” and for illustration purposes it will be assumed that the number of printing levels (i.e., halftone levels) will be 3, corresponding to 0, 1, or 2 ink drops at a given pixel. The halftoning algorithm may take many forms, as will be understood by one skilled in the art, and is not fundamental to the present invention.

The print image data 30 is then processed by a swath generator 40 to create swath image data 50. The swath image data 50 represents the data that is required to be printed by one pass of the printhead, and is conditioned to be sent to an inkjet print engine 60. The swath image data contains binary information that instructs the printer to eject a drop of ink or not for each ink color at each pixel in the swath. The pixels in the swath are stored at the printing resolution, and can thus be referred to as printer pixels. The swath generator 40 contains an algorithm commonly called “print masking” or “shingle masking” that takes a strip of print image data 30 and separates it into a number of swath image data strips, where the number of swath image data strips corresponds to the number of print passes that is desired for the given strip of the image. The details of the print masking algorithm are beyond the scope of the present description, and will be understood by one skilled in the art.

Finally, the swath image data 50 is sent to the inkjet print engine 60, which contains an inkjet printhead having a plurality of ink nozzles for ejecting drops of ink for a set of ink colors, typically cyan, magenta, yellow, and black. For illustration purposes, it is assumed that the ink nozzles can eject a single drop of a fixed size for each of the ink colors at each pixel location in a single pass of the printhead across the page. Typically, the inkjet printhead will have several hundred ink nozzles for each ink color arranged in a vertical column. The spacing between the ink nozzles is such that the height of the printhead is typically 0.5-1.0 inch, which corresponds to the height of a print swath as the printhead is moved horizontally across the page.

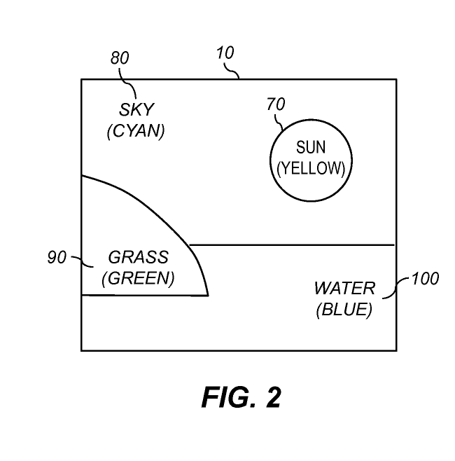

Turning now to FIG. 2, a sample input digital image 10 is shown which represents a typical image that would be supplied by a host computer or other image source and printed on an inkjet printer using the generic image pipeline shown in FIG. 1. In FIG. 2, the input digital image 10 is a contone RGB image (i.e., 256 tone levels at each pixel for each of the RGB color channels) containing a yellow sun region 70, a cyan sky region 80, a green grass region 90, and a blue water region 100 corresponding to sun, sky, grass, and water objects in the image, respectively. The input digital image 10 is composed of thousands of individual image pixels, which have been omitted from the figure for clarity. One skilled in the art will be familiar with digital representation of images by individual pixels. For illustration purposes, it will be assumed that the image pixels in each of the image regions all have the same code value.

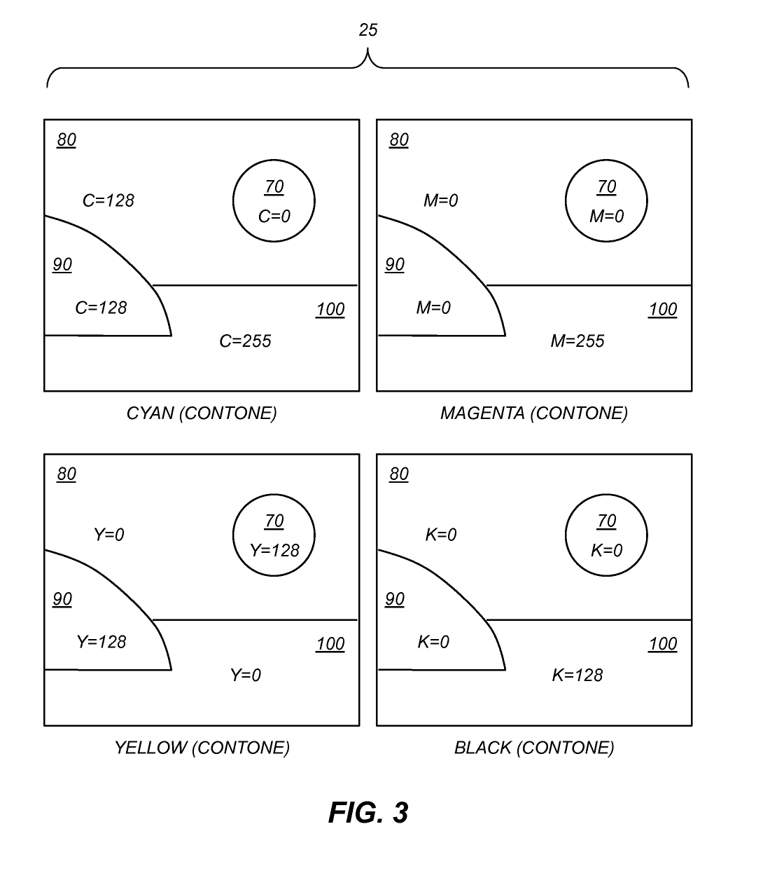

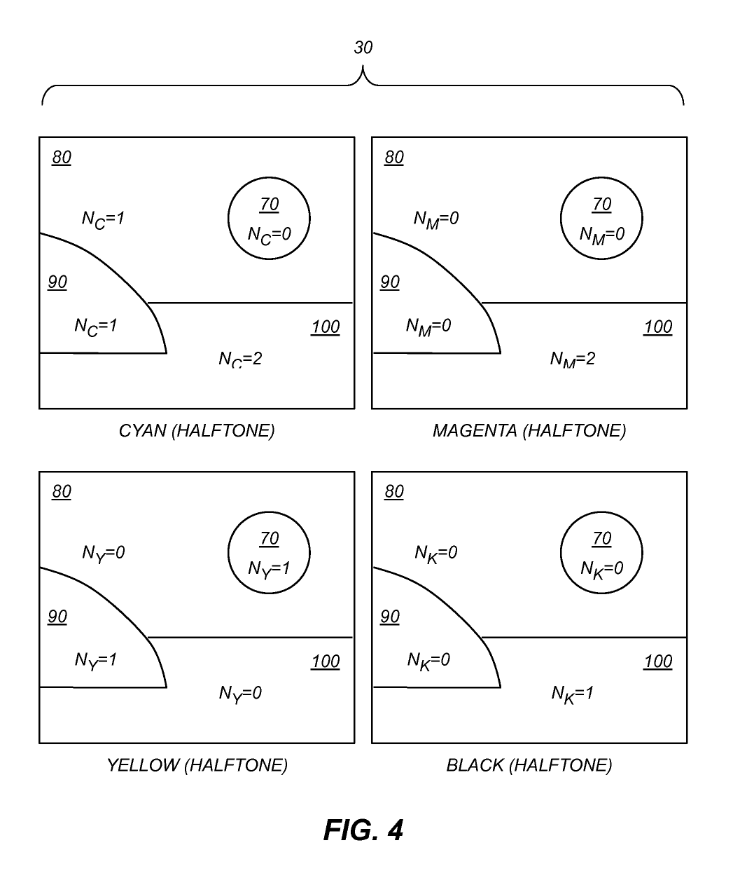

The input digital image 10 of FIG. 2 is processed through the raster image processor 20 (FIG. 1) to produce contone color managed image data 25 (shown in FIG. 3), and ultimately to produce halftoned print image data 30 (shown in FIG. 4). It can be seen from the color managed image data 25 of FIG. 3 that the input digital image has been converted from an RGB color space representation to a corresponding CMYK color space representation corresponding to the color channels of the inkjet printer.

In FIG. 3, each of the color channels (cyan, magenta, yellow and black) is shown as a separate color separation. Each of the image regions in the color separations have indicated within them the contone code values representing the amount of the corresponding ink color that is to be printed in that region. For example, in the green grass region 90, it can be seen that the contone CMYK code values for pixels within that region are CMYK={128, 0, 128, 0} to produce the green color. The process of color conversion from RGB to CMYK is well known in the art as a required process for inkjet printers, and is not fundamental to the present invention.

The color managed image data 25 shown in FIG. 3 is then further processed by the raster image processor 20 (FIG. 1) to produce the halftoned print image data 30 shown in FIG. 4. In FIG. 4, each of the image regions now indicate the number of ink drops of each ink color that are desired to be printed at each pixel location within the region, denoted by the values N_{c}, Nₘ, N_{y}, and Nₖ, which indicate the number of ink drops for cyan, magenta, yellow, and black color channels, respectively. For example, the cyan sky region 80 of the image will receive one drop of cyan ink only, and the blue water region 100 of the image will receive two drops of cyan ink, two drops of magenta ink, and one drop of black ink to produce the desired color. (These particular values are chosen for illustration purposes only, and one skilled in the art will recognize that other values are possible, including non-integer values which would indicate mixtures between two different halftone levels.) For example, in the sky region, the number of drops of cyan ink that is required might be 1.5, which would indicate that half of the sky pixels would receive one drop of cyan ink, and the other half would receive two drops of cyan ink, so that the average amount of cyan ink printed at each pixel in the sky would be 1.5 drops, thereby producing the desired color. The decision of which pixels receive one drop vs. two drops is the job of the halftoning algorithm in the raster image processor 20, as will be understood by one skilled in the art.

After the halftoned print image data 30 is created by the raster image processor 20 of FIG. 1, a swath generator 40 processes the print image data to create swath image data 50. The swath image data 50 contains binary information for controlling the ejection of the ink drops in each pass of the printhead. The difference between the print image data 30 and the swath image data 50 is that the print image data 30 contains information about how many drops of each ink color are to be printed at each image pixel, whereas the swath image data 50 contains information about which image pixels receive an ink drop on a particular print pass. Conceptually, the swath image data 50 is the print image data 30 split up into a number of individual print passes. The algorithm that controls this process is commonly called print masking, and is provided within the swath generator 40. Print masking will be known to one skilled in the art, and is not a fundamental aspect of the present invention.

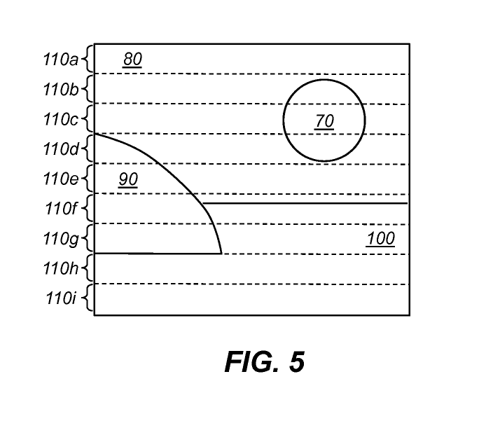

Another function of the swath generator 40 is to format the swath image data into horizontal strips that correspond to the height of the printhead as it traverses across the page. These strips can be projected back onto the print image data to identify regions of pixels in the image that get printed together in the same swath. These are shown as image strips 110a-110i in FIG. 5. For example, image strip 110d shows that the bottom part of the yellow sun region 70 will be printed in the same swath as the very top portion of the green grass region 90. Since the number of ink drops chosen for this example can be 0, 1, or 2 at each pixel, then without further information, the printhead must pass over each pixel location on the page at least two times, to facilitate the printing of two ink drops at any given pixel, should that be required. Since each image strip 110a-110i of the image shown in FIG. 5 contains color information, the prior art techniques would print each strip using at least two passes. However, as will now be shown, this can be substantially improved upon by using the advantageous features of the present invention, which recognizes that not every image strip 110a-110i of the image requires two passes, since not every image strip 110a-110i of the image will contain image pixels that require two drops of ink. This is a fundamental advantage of the present invention, and will now be discussed in detail.

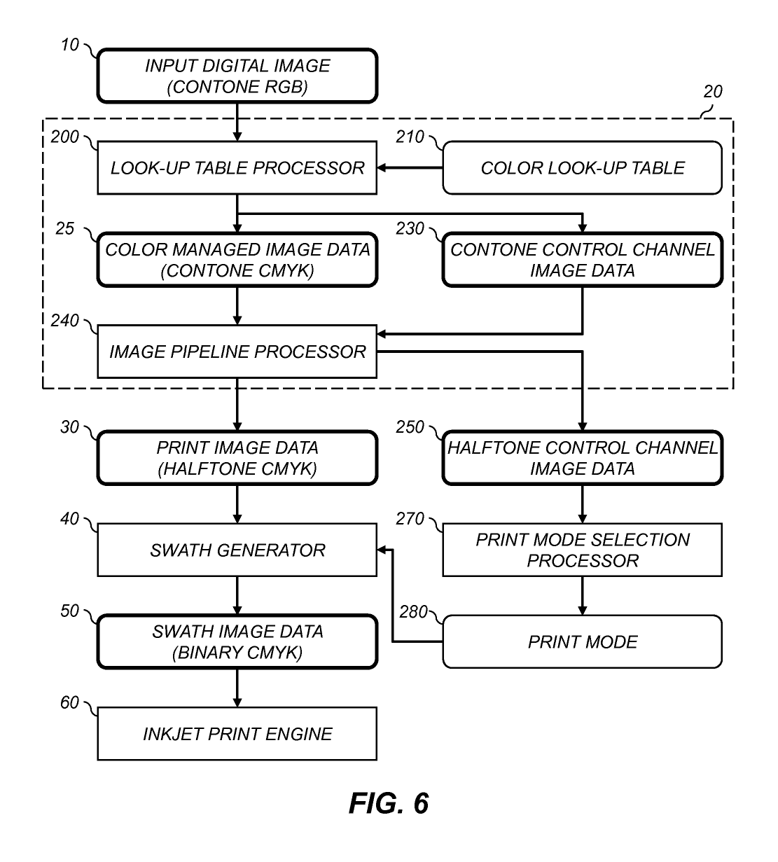

Turning now to FIG. 6, a preferred embodiment of the present invention will be discussed. FIG. 6 shows an image processing pipeline similar to FIG. 1, but with more detail and additional components according to an embodiment of the present invention. The raster image processor 20 includes a look-up table processor 200, which uses a multi-dimensional color look-up table 210 to convert the input digital image 10 from the input RGB color space representation to the CMYK color space of the inkjet printer, represented as contone color managed image data 25. Additionally, the look-up table processor 200 generates contone control channel image data 230, which contains a control value for each pixel that will be used to determine the number of print passes required to print the pixel.

The color managed image data 25 and the contone control channel image data 230 are processed by an image pipeline processor 240, which contains the remainder of the image pipeline algorithms described earlier, such as resizing, halftoning, etc. An output of the raster image processor 20 is the print image data 30 as described earlier, but also another output is halftone control channel image data 250, which has been halftoned and processed through the image pipeline processor 240 just as if it was another ink channel of the image.

A print mode selection processor 270 then analyzes the halftone control channel image data 250 for each strip of the image to select a print mode 280 that will be used to print the strip. The print mode 280 that is selected for a strip is then passed to the swath generator 40, which uses the selected print mode 280 to process the print image data 30 into the swath image data 50, which is then sent to the inkjet print engine 60 for printing.

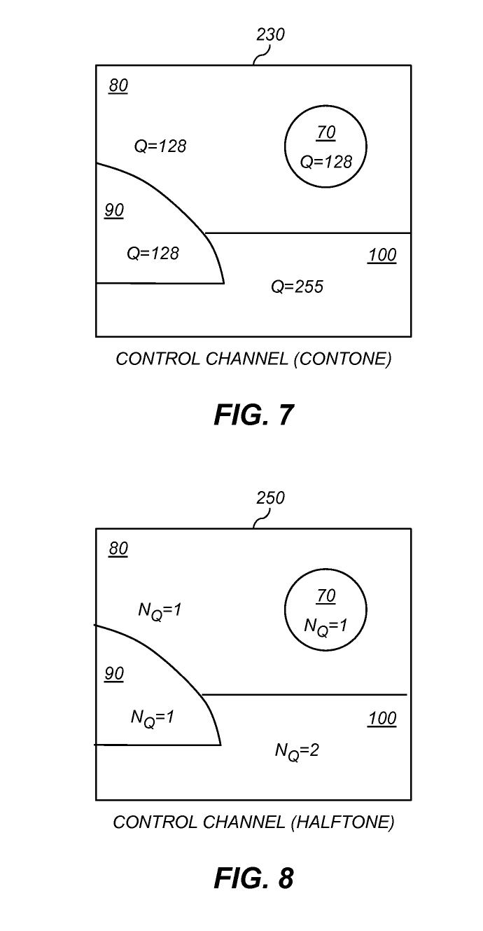

The control channel image data is an important feature of the present invention, and a detailed example of how it is used to advantageously control the printing of an inkjet image will now be described. Returning to a discussion of the sample input digital image 10 of FIG. 2, FIG. 7 shows exemplary contone control channel image data 230 for each image region. The pixel values of the contone control channel image data 230 are denoted by the variable Q. In a preferred embodiment, a control value Q is pre-computed and stored for each node of the color look-up table 210 of FIG. 6 as an additional output value, and the contone control channel image data 230 is generated by using the look-up table processor 200 to provide an additional output value of the interpolation process. In a preferred embodiment, the control value Q provides an indication of whether the RGB code values for a given node would require more than one drop of any ink color. If more than one drop of any ink color is required, then the control value is set to a high value (e.g., 255) that indicates that more than one pass of the printhead is required to print the color. If at most 1 drop of any ink color is required, then the control value is set to a low value (e.g., 128) to indicate that only one pass of the printhead is required to print the color.

Referring to FIG. 7, a control value Q is shown for each of the image regions in the input digital image 10 (FIG. 2). From the print image data 30 of FIG. 4, it can be seen that the maximum number of ink drops required to be printed in any color is one for the yellow sun region 70, the cyan sky region 80, and the green grass region 90, and the maximum number of ink drops for the blue water region 100 is two. Thus, the control value Q shown in FIG. 7 is set to a low value (i.e., Q=128) for the yellow sun region 70, the cyan sky region 80, and the green grass region 90, and a high value (i.e., Q=255) for the blue water region 100.

Next, referring back to FIG. 6, the contone control channel image data 230 is processed by the image pipeline processor 240 to generate halftone control channel image data 250. For the sample input digital image 10 (FIG. 2), exemplary halftone control channel image data 250 is shown in FIG. 8. It can be seen that the value of the halftone control channel image data 250 for the yellow sun region 70, the cyan sky region 80, and the green grass region 90 is N_{Q}=1, and the value for the blue water region 100 is N_{Q}=2. The value N_{Q}=1 provides an indication to the swath generator 40 that only one pass is required in the region, and the value N_{Q}=2 provides an indication to the swath generator 40 that two passes are required in the region.

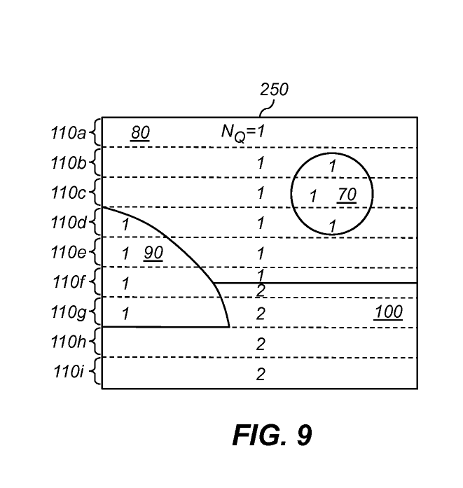

The print mode selection processor 270 of FIG. 6 then analyzes the halftone control channel image data 250 on a strip-by-strip basis to determine the print mode 280 that should be used for each image strip. In FIG. 9, the halftone control channel image data 250 is overlaid with the image strips 110a-110i of FIG. 5. The halftone control values N_{Q} are indicated for each region within each image strip. In an exemplary embodiment, the print mode selection processor simply examines the halftone control channel image data 250 for a given image strep to determine whether one or more halftone control values have a value of N_{Q}>1. In other embodiments, the halftone control channel image data 250 can perform a more sophisticated statistical analysis of the halftone control channel image data 250. For example, if only a small number of isolated pixels have halftone control values where N_{Q}>1, it can be appropriate to use a one-pass print mode without any significant impact on image quality. In some embodiments, a number of pixels in a particular image strip that have halftone control values that exceed a predefined first threshold is determined (e.g., the number of pixels where N_{Q}>1). If the determined number of pixels is less than a predefined second threshold then the print mode selection processor 270 selects a one-pass print mode even though a small number of pixels in the strip would normally have been printed using a two-pass print mode.

For image strips 110a-110e near the top of the image, which include only pixels in the yellow sun region 70, the cyan sky region 80, and the green grass region 90, the halftone control values for every pixel within the image strip 110a-110e has the value “1,” indicating that only one drop of ink is required. Since all pixels within each of these image strips 110a-110e require at most 1 drop of ink of any color, this implies that the image strips 110a-110e can be printed in one pass. Accordingly, the print mode selection processor 270 sets the print mode 280 to a one-pass print mode for these image strips 110a-110e. The swath generator 40 (FIG. 6) creates swath image data 50 (FIG. 6) for these image strips 110a-110e for a one-pass print mode, and the inkjet print engine 60 prints the image strips 110a-110e in one pass each.

In FIG. 9, image strips 110f-110i include pixels in the blue water region 100 (as well as other pixels in the cyan sky region 80 and the green grass region 90). Since the blue water region 100 has a halftone control channel image data value of “2,” indicating that two drops of ink are required for at least one ink color, image strips 110f-100i must therefore be printed in two passes. Thus, the print mode 280 is set to a two-pass print mode for the image strips 110f-110i. The swath generator 40 (FIG. 6) creates swath image data 50 (FIG. 6) for image strips 110f-100i for a two-pass print mode, and the inkjet print engine 60 prints the image strips 110f -110i in two passes each.

In this fashion, the present invention prints any image strip that is capable of being printed in one pass with a one-pass print mode, regardless of whether the image strip contains color information, black information, or a mixture of both. This provides for a significant reduction in print time, and an advantage over the prior art methods. Additionally, since the halftone control channel image data 250 is a single channel, the print mode selection processor 270 simply has to analyze a single channel of information to determine if any of the pixels in the strip require two drops of ink. It is not necessary to analyze all of the ink channels, thereby saving calculations and potentially saving more time.

While printing an input digital image 10 according to the method of the present invention provides for faster print times with high image quality, it has been observed that even though some colors are capable of being printed in one pass, chromatic banding artifacts can still be objectionable. For example, consider the green grass region 90 of the input digital image shown in FIG. 2. The print image data for this region requires 1 drop of cyan ink and 1 drop of yellow ink to be printed at each pixel, as shown in FIG. 4. Therefore, the green grass region 90 is capable of being printed in one pass. However, if the image is printed in a one-pass bi-directional print mode, in one print direction the yellow ink will be printed on top of the cyan ink, while in the other print direction the cyan ink will be printed on top of the yellow ink. Depending on the ink, media and printer characteristics, this can result in objectionable chromatic banding.

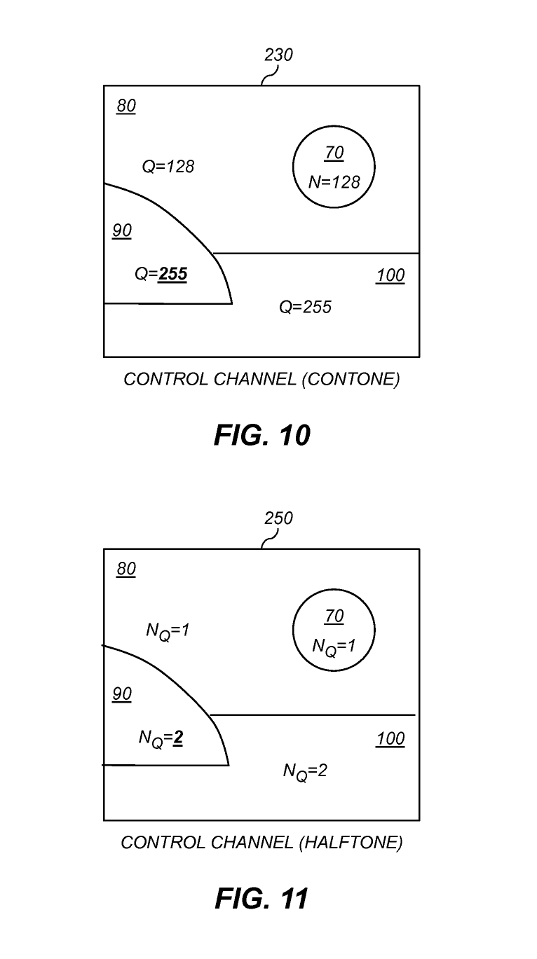

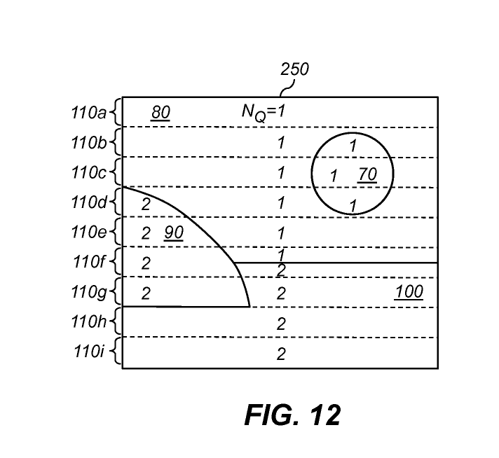

In some embodiments, chromatic banding artifacts can be substantially reduced by altering the contone control value stored in the color look-up table 210 for colors that are susceptible to chromatic banding to have a higher value (e.g., Q=255). Accordingly, the contone control channel image data 230 that is generated for the input image of FIG. 2 will have higher contone control values in the green grass region 90 as shown in FIG. 10. The halftone control channel image data 250 will in turn have a halftone control value of N_{Q}=2, as shown in FIG. 11. As shown in FIG. 12, this in turn causes the image strips 110d-110e to print in a two-pass print mode (in addition to image strips 110f-110i). In this way, by adjusting the control values stored in the color look-up table 210, specific colors can be selected and forced to print in a two-pass print mode to prevent chromatic banding artifacts, while other colors that do not produce objectionable chromatic banding are allowed to print in a one-pass print mode. The fact that the control value is stored as another channel of the color look-up table 210 provides for a high degree of flexibility in optimizing the print speed and image quality.

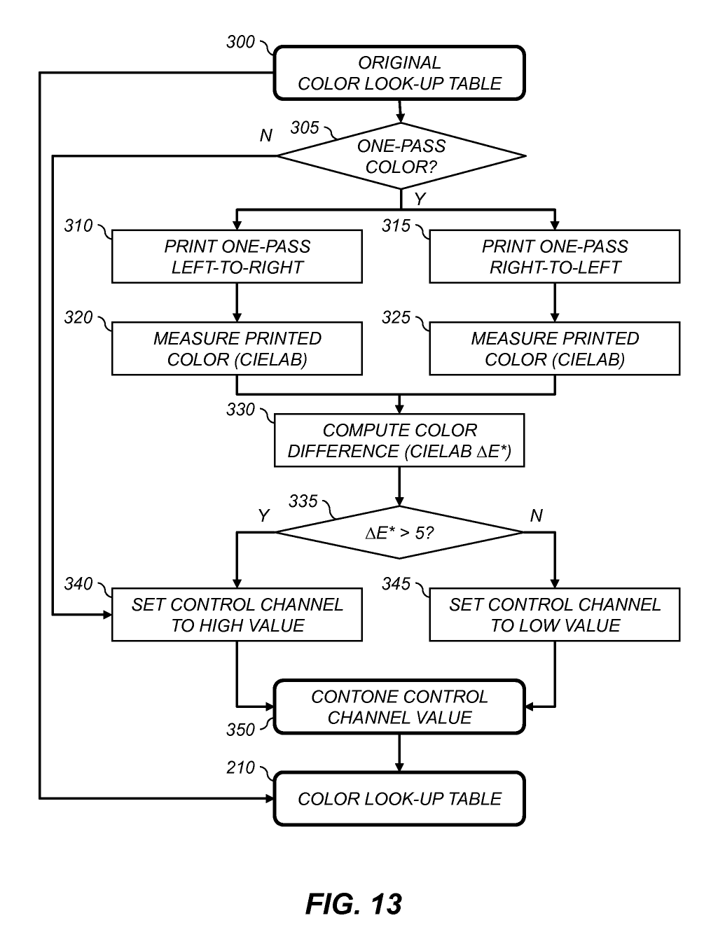

FIG. 13 shows a flow chart of a method for creating a multi-dimensional color look-up table 210 according to a preferred embodiment of the present invention. An original color look-up table 300 is a conventional color transform for performing a color space conversion from an RGB set of input colors to the CMYK color space of the inkjet printer. The original color look-up table 300 is typically three-dimensional look-up table that stores contone CMYK color values for a lattice of contone RGB color values (e.g., a 9³ or 17³ grid of RGB values). The original color look-up table 300 is typically created as part of a printer characterization process, the details of which are beyond the scope of this invention and will be familiar to those skilled in the art.

A one-pass color test 305 is used to analyze the nodes of the original color look-up table 300 to identify those corresponding to colors that can be printed using one-pass (i.e., colors where no more than one ink drop is required for any color). In some embodiments, the one-pass color test 305 calculates the number of ink drops required for each of the CMYK color channels. If the maximum number of ink drops for any color channel is no more than one, then the color can be printed in one pass. For any colors that require more than one pass (i.e., at least one color channel requires more than one drop), a set control channel to high value step 340 is used to set a contone control channel value 350 to a high value (e.g., 255), which indicates that more than one pass is required.

For the colors that can be printed with one pass, a print one-pass left-to-right step 310 is used to print a patch having the corresponding color value where the printhead is moved across the page left-to-right. Similarly, a print one-pass right-to-left step 315 is used to print a patch having the corresponding color value where the printhead is moved across the page right-to-left, thereby inverting the laydown order of the inks Chromatic banding will manifest itself as a color difference between the two patches.

Measure printed color steps 320 and 325 are used to measure the printed patches printed in the two directions using an appropriate color measuring device such as a spectrophotometer or a colorimeter, the use of which will be well known to those skilled in the art. In a preferred embodiment, the measured colors are represented in the well-know CIELAB color space, although any color space that represents the patch color for a human observer can be used. Examples of other color encodings that could be used to represent the patch colors would include the CIELUV color space and the CIECAM02 color appearance space.

A compute color difference step 330 is used to compute the perceived color difference between the two measured colors. In a preferred embodiment, the color difference is represented using the well-known CIELAB ΔE*, although any appropriate perceived color difference metric known in the art can alternatively be used. The color difference value represents the perceived color difference that would be observed if the color was printed in a one-pass bi-directional print mode for two subsequent passes printed in opposite directions.

A comparator 335 is used to compare the color difference value against a predefined threshold (e.g., ΔE*=5) to determine if the color difference is objectionable or not. If the color difference is less than or equal to the predefined threshold, then the level of chromatic banding that would result from printing the color in a one-pass bi-directional print mode will not be objectionable. In this case, a set control channel to low value step 345 is used to set the contone control channel value 350 to a low value (e.g., 128). Otherwise, if the comparator 335 determines that the color difference is larger than the predefined threshold, then the level of chromatic banding that will result from printing the color in a one-pass bi-directional print mode will be objectionable, and the set control channel to high value step 340 is used to set the contone control channel value 350 to a high value (e.g., 255). This will force this color to print in two passes to prevent objectionable chromatic banding artifacts from occurring, even though the color could be printed with only one pass.

The color look-up table 210 is then formed by adding the determined contone control channel value 350 as an additional color channel together with the CMYK color channels of the original color look-up table 300. The color look-up table 210 is then used to control the printing of the inkjet image according to the present invention as described above with respect to FIG. 6.

The method for determining the contone control channel values 350 described in FIG. 13 is based on determining the objectionability of chromatic banding artifacts. This same approach can be used for other printer artifacts besides chromatic banding as well (e.g., gloss banding artifacts and streak artifacts). In particular, it is useful for artifacts that are more objectionable for some colors than for others, and where the objectionability of the artifacts can be reduced using a larger number of print passes. In such cases, rather than computing a ΔE* color difference, which is compared to a threshold, some other appropriate measure of the artifact magnitude can be determined and compared to an appropriate threshold. Appropriate methods for characterizing various printer artifacts will be well-known to those skilled in the art.

The invention has been described in detail with particular reference to certain preferred embodiments thereof, but it will be understood that variations and modifications can be effected within the spirit and scope of the invention. For example, it will be known to one skilled in the art that the invention will apply equally well to inkjet printers using a different set or different number of inks, such as printers that use multiple shades of gray ink, or multiple shades of cyan or magenta inks

The invention will also apply equally well to other printmodes that have higher numbers of passes. For example, the invention will apply to an inkjet printer that can print more than two drops of ink at each image pixel, or prints images in more than two print passes. The invention would apply equally well to select between print modes having two and three passes, for example, or any two print modes having any number of passes. The invention could also be easily extended to select between more than two print modes as well.

Consider the case of a printer that is adapted to print 0, 1, 2 or 3 drops of a particular color ink at each image pixel, and can print in a one-pass print mode, a two-pass print mode, or a three-pass print mode. In such cases, the control channel value stored in the color look-up table 210 (FIG. 6) can provide an indication of the minimum number of passes that are required to print each color. For example, the control channel value can be set to a low value (e.g., 85) for colors that can be printed with at most one drop of any color ink (and therefore can be printed with a one-pass print mode); it can be set to a medium value (e.g., 170) for colors that can be printed with at most two drop of any color ink (and therefore requires a two-pass print mode); and it can be set to a high value (e.g., 255) for colors that require three drops of at least one color ink (and therefore requires a three-pass print mode). As was described earlier, the control channel values stored in the color look-up table 210 can also be set to reflect the minimum number of passes that are required to avoid objectionable chromatic banding. For example, if a particular color that can be printed with a two-pass print mode exhibits objectionable chromatic banding, then the control channel value can be set to the high value rather than the medium value. The halftone control channel image data 250 (FIG. 6) determined in this case would have values of 1, 2 or 3. For image strips where the maximum halftone control value is “1,” a one-pass print mode can be selected; for image strips where the maximum halftone control value is “2,” a two-pass print mode can be selected; and for image strips where the maximum halftone control value is “3,” a three-pass print mode can be selected.

It will also be known to one skilled in the art that the image processing described within the scope of the invention could be performed on a host computer, or equally well on an embedded CPU or logic within the inkjet printer itself.

### PARTS LIST

10 input digital image
20 raster image processor
25 color managed image data
30 print image data
40 swath generator
50 swath image data
60 inkjet print engine
70 yellow sun region
80 cyan sky region
90 green grass region
100 blue water region
110a-110i image strip
200 look-up table processor
210 color look-up table
230 contone control channel image data
240 image pipeline processor
250 halftone control channel image data
270 print mode selection processor
280 print mode
300 original color look-up table
305 one-pass color test
310 print one-pass left-to-right step
315 print one-pass right-to-left step
320 measure printed color step
325 measure printed color step
330 compute color difference step
335 comparator
340 set control channel to high value step
345 set control channel to low value step
350 contone control channel value

1. A method of using an inkjet printer to print an input digital image having a plurality of rows and columns of input pixels, each input pixel having an input color specified by input code values for one or more input color channels, wherein the inkjet printer includes a printhead having ink nozzles for printing print image data by ejecting ink drops of one or more ink colors for an array of printer pixels, said inkjet printer being adapted to print horizontal strips of print image data using one or more print passes, comprising:
a) determining print image data for a particular strip responsive to input code values for corresponding input pixels, the print image data providing an indication of a number of ink drops of each ink color to be printed for corresponding printer pixels;
b) determining control channel image data for the particular strip responsive to the input code values for the corresponding input pixels, wherein the control channel image data provides an indication of the number of print passes that should be used to print the input code values;
c) determining a number of print passes for the particular strip responsive to the determined control channel image data;
d) controlling the inkjet printer to print the particular strip of print image data using the determined number of print passes; and
e) repeating steps a)-d) for each strip required to print the input digital image.

2. The method of claim 1 wherein the control channel image data is determined using a multi-dimensional look-up table indexed by the input code values for the one or more input color channels of the input digital image.

3. The method of claim 1 wherein the control channel image data corresponding to a particular printer pixel is determined responsive to the number of ink drops of each ink color to be printed for the particular printer pixel.

4. The method of claim 3 wherein the control channel image data provides an indication of a maximum number of ink drops of any one ink color that are to be printed for the particular printer pixel.

5. The method of claim 4 wherein the number of print passes for the particular strip is determined responsive to the largest maximum number of ink drops for the printer pixels in the particular strip.

6. The method of claim 5 wherein the number of print passes for the particular strip is equal to the largest maximum number of ink drops for the printer pixels in the particular strip.

7. The method of claim 5 wherein the number of print passes for the particular strip is greater than the largest maximum number of ink drops for the printer pixels in the particular strip in order to reduce printing artifacts.

8. The method of claim 5 further including:
determining a number of pixels in the particular strip for which the control channel image data exceeds a first predefined threshold, and;
if the determined number of pixels is less than a second predefined threshold, setting the number of print passes to be used for the particular strip to a value less than the largest maximum number of ink drops for the printer pixels within the strip.

9. The method of claim 1 further including:
identifying a set of input colors that can be printed with a single print pass;
printing the set of input colors using a single leftward pass to provide a first set of printed colors;
printing the set of input colors using a single rightward pass to provide a second set of printed colors; and
measuring a color difference between corresponding printed colors in the first and second sets of printed colors;
wherein the control channel image data corresponding to a particular printer pixel is determined responsive to the color differences.

10. The method of claim 8 wherein the control channel image data is determined using a multi-dimensional look-up table indexed by the input code values for the one or more input color channels of the input digital image, the multi-dimensional look-up table storing control channel image data for a lattice of input colors, and wherein the control channel image data corresponding to input colors that can be printed with a single print pass are determined responsive to the color differences for those input colors.

11. The method of claim 9 wherein the color differences are compared to a predefined threshold, and wherein the control channel image data for input colors where the color difference exceeds the predefined threshold are set to provide an indication that more than one print pass is required.

12. The method of claim 9 wherein the control channel image data corresponding to input colors that cannot be printed with a single print pass are set to provide an indication that more than one print pass is required.

13. The method of claim 8 wherein the color difference is represented using a CIELAB ΔE* value.

14. The method of claim 1 wherein different strips of the print image data are printed with different numbers of print passes.
